(19) United States
(12) Patent Application Publication
(10) Pub. No.: US 2016/0294758 A1
(43) Pub. Date: Oct. 6, 2016

(54) Mail Routing and Analytics System

(71) Applicant: Applications Consulting Training Solutions, Inc., Jacksonville, FL (US)

(72) Inventor: James Farhat, Jacksonville, FL (US)

(73) Assignee: Applications Consulting Training Solutions, Inc., Jacksonville, FL (US)

(21) Appl. No.: 15/010,508

(22) Filed: Jan. 29, 2016

Related U.S. Application Data
(60) Provisional application No. 62/110,178, filed on Jan. 30, 2015.

(51) Int. Cl. H04L 12/58; G06K 9/62; G06K 9/00

(52) U.S. Cl. CPC H04L 51/22; H04L 51/36; G06K 9/00463; G06K 9/00456; G06K 9/6262; G06K 2209/01

(57) ABSTRACT

A mail capture and routing system for digitally capturing information from physical mail items, using such information for routing the captured mail to an appropriate addressee and integrating such information into existing messaging and/or document management systems. The methods include digitally scanning an image of the mail item, and reading text from the scanned image to create metadata content. A digital mail file comprising the scanned image and the metadata content is created, and the data in the metadata content is used to perform an action on the digital mail file, the action including forwarding the digital mail file via email to an addressee identified in the metadata content. The addressee can be identified by checking additional information associated with the addressee in memory of the computer system. The system and methods include machine learning algorithms so the accuracy of the addressee identification can be checked and improved over time, and can add additional layers of actions. Users can interact with the digital mail file representing the physical mail file, preferably in a unified messaging system.

### CROSS-REFERENCE TO RELATED APPLICATIONS

This application claims the benefit of U.S. provisional patent application No. 62/110,178, filed Jan. 30, 215, the entire contents of which is incorporated herein.

### FIELD OF THE INVENTION

This disclosure relates to technologies for mail routing and analytics systems, and particularly to methods and systems for digitally capturing information from physical mail items, using such information for routing the captured mail to an appropriate addressee, for integrating such information into existing messaging, line of business, and/or document management systems, and for conducting analytics on such mail items.

### BACKGROUND OF THE INVENTION

As the majority of business communication is now conducted via email, companies and other organizations are looking to downsize and integrate the processing of physical mail items that are still being received, albeit in lesser quantities than in the past. Organizations have up to now required physical space to be set aside for bin or bin-like containers for mail sorting and storage, and/or labor to deliver this postal mail to the intended recipient.

With technological advancements, mailroom automation has become more and more desirable by the Global 1000 organizations due to its robustness and cost effectiveness. Unlike traditional mail processing, digital mail capture systems allow physical mail items to be scanned and forwarded via email. Systems and methods exist to enable the scanning and capturing of mail, and to run an OCR (optical character recognition) process or other methods of data recognition to create searchable text from the mail item. However, existing systems suffer from various drawbacks, including the need to continue to employ staff to decide which user an item of mail is addressed to, and to forward the email appropriately. Furthermore, when an item is merely routed as an attachment to an email, it requires processing by a recipient in order to appropriately enter it into a workflow process, such as an Accounts Payable system, for example. Some mail capture or scanning systems can enable documents to be stored in a document management system, but again require the employment of staff in order to make decisions on the appropriate storage location/workflow that the document should be sent to.

### SUMMARY OF THE INVENTION

A system and accompanying methods for digitally capturing and processing physical mail items are disclosed. In particular, this disclosure relates to a mail routing and analytics systems and methods for digitally capturing information from physical mail items, for using such information for automatically routing the captured mail to an appropriate addressee and for integrating such information into existing messaging, line of business, and/or document management systems. The methods include digitally scanning an image of the mail item, and reading text from the scanned image to create metadata content attached to the image. A digital mail file comprising the scanned image and the metadata content is created, and the methods include using the data in the metadata content to perform an action on the digital mail file, the action including forwarding the digital mail file via email to a user, group, or line of business system (LOB) identified in the metadata content. The user, group or LOB system can be identified by checking additional information associated with the user, group or LOB in the memory of the computer system. The system and methods include machine learning algorithms so that the accuracy of the addressee identification can be checked and improved over time, and can add additional layers of actions. The system and methods additionally allow users, groups, or the LOB system to interact with the digital mail file representing the physical mail file, preferably in a unified messaging system.

The system and methods use various machine learning algorithms to provide named entity recognition (this identifies the name of the person or department the mail is addressed by performing a look-up to the directory service), sentiment analysis to identify the sentiment of the postal mail (for example, if the mail relates to a violation and has key words that are similar to “violation”, the item can be automatically transferred to a compliance or legal department), object analytics (identifying based on pictures where postal mail may need to go), and semantic analytics can be applied against many of these other items. This machine learning allows for the system and methods to become more accurate as times goes on.

The mail can be delivered into an organization's unified messaging client which for most customers is Microsoft Outlook. The system and method can be a cloud based application or can be supported on premise.

The user has the ability to provide other learning and reclassification of the documents inside their unified messaging client (for example Outlook). They are also able inside their unified messaging client able to request a hard copy which sends a message to the mailroom administrator, forward to another person, or department, and/or route to a workflow. This gives user and distributed capabilities for machine learning to take these signals and events and become more accurate. The machine learning algorithms can use both the mailroom administrator's customized rules that they can enter, and feedback and actions taken by the users to provide signals for machine learning to become more accurate.

This system and method provide the ability to take postal mail, identify the addressee and link it to a resource directory, while delivering the mail based on a department, process, or person to their unified messaging application such as an email client. The system requires less labor, no physical sorting bins, and allows for intelligent capture using OCR. Machine learning improves the accuracy. Once in a unified messaging system (for example, Outlook), the content can be directly routed to workflow, line of business, and/or business intelligence functions, which can help with additional savings cost within different processes in the business.

Likewise, this system and method provide the ability to take digital postal mail and attach metadata and show it to the interface that someone uses for email, voice and other messaging content. Once mail containing structured metadata is received, several additional functionalities can be provided to the end user for a seamless experience. These functions are inclusive of both workflow capabilities and business intelligence—pertaining to data analytics.

Workflow capabilities also include mail alerts, notifications, approvals, forwarding internally or externally or to another process outside the system, delivering hard copy request, selecting to include in a document set, integrating metadata to another system, making calculations, providing qualitative analysis, using machine learning, and other content related operations that drive process or visibility with insights.

These and other features of the systems and methods for mail capturing are described in the following detailed description, drawings, and appended claims.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a schematic illustration of an arrangement of a mail capture and routing system according to the present arrangements.

FIG. 2 is a sketch illustrating components of the mail capture and routing system;

FIG. 3 is a flow diagram illustrating a mail capture method according to the present arrangements.

FIG. 4 is an exemplary screen shot showing a captured image file together with a metadata file.

FIG. 5 is an exemplary screen shot showing an email layout together with a metadata file.

FIG. 6 is an illustrative embodiment of a general computer system.

The use of the same reference symbols in different drawings indicates similar or identical items.

### DETAILED DESCRIPTION OF INVENTION

The numerous innovative teachings of the present application will be described with particular reference to exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

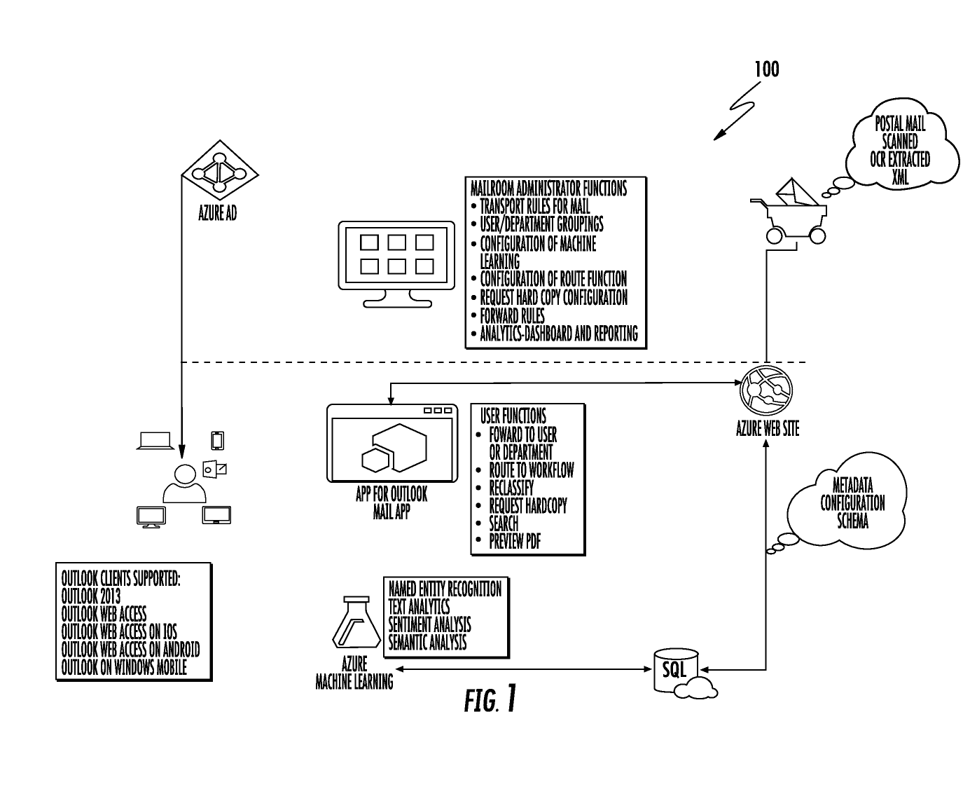

The systems and methods described herein and in FIGS. 1-6 allow the postal mail received at an organization to be consolidated with other unified messaging that the user might have on a mobile device, web-based, or desktop device. It allows for the capture of metadata relating to an item of physical mail, and provides the ability to route a digital version of that mail item based upon the captured metadata. In addition, it provides the ability to build up and use this captured information to allow workflow functions and business intelligence (visibility) functions. In particular, the systems and methods may utilize cloud-computing resources and metadata to achieve these aims. Notably, the systems and methods described herein are more than just a mail capture system. The logic and routing of mail described herein using algorithms to a person, group, department, line of business (LOB) system or process that can be driven contextually to a workflow and/or unified messaging client are flexible and can be used to incorporate analytics as well as improve accuracy of the routing. Since the postal mail is routed to a unified messaging client and server (for example: Exchange and Outlook) it brings a benefit to the user to have it in the same place as their electronic mail. Other benefits include providing better context with postal mail using sentiment analysis, text analytics, object analytics, and semantic analytics on the postal mail to have a better delivery to either person, department and/or process.

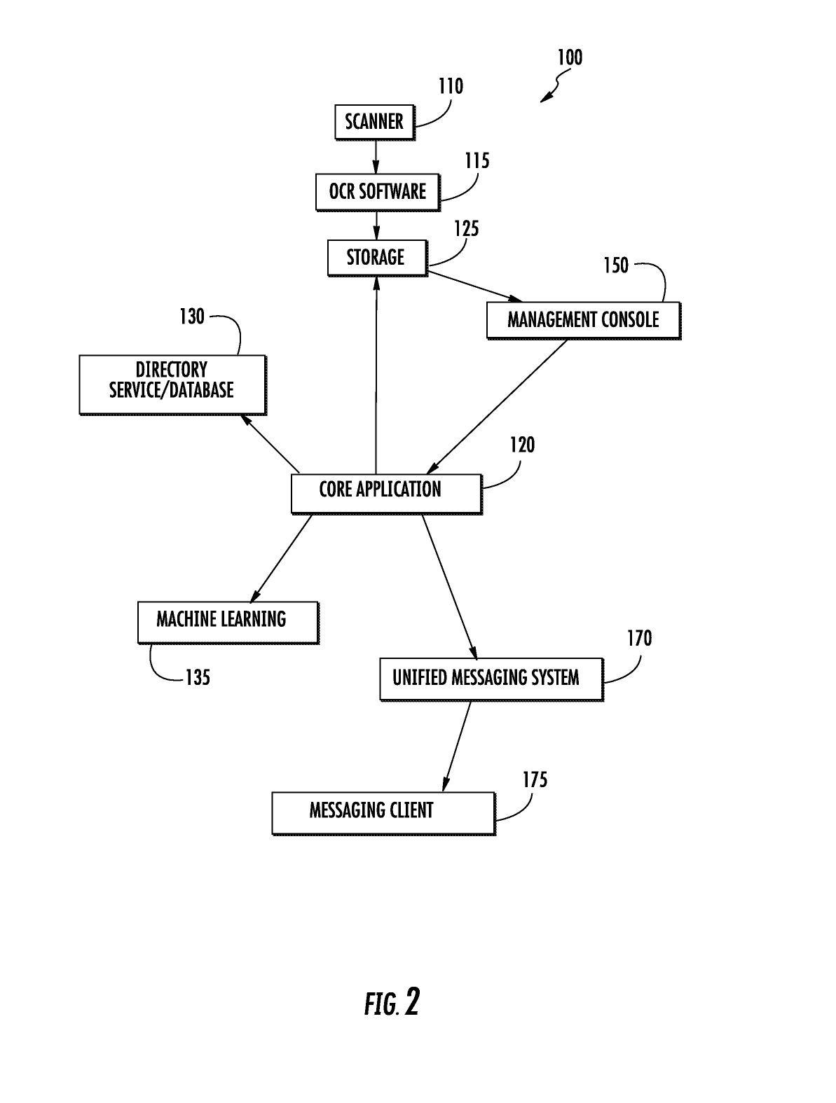

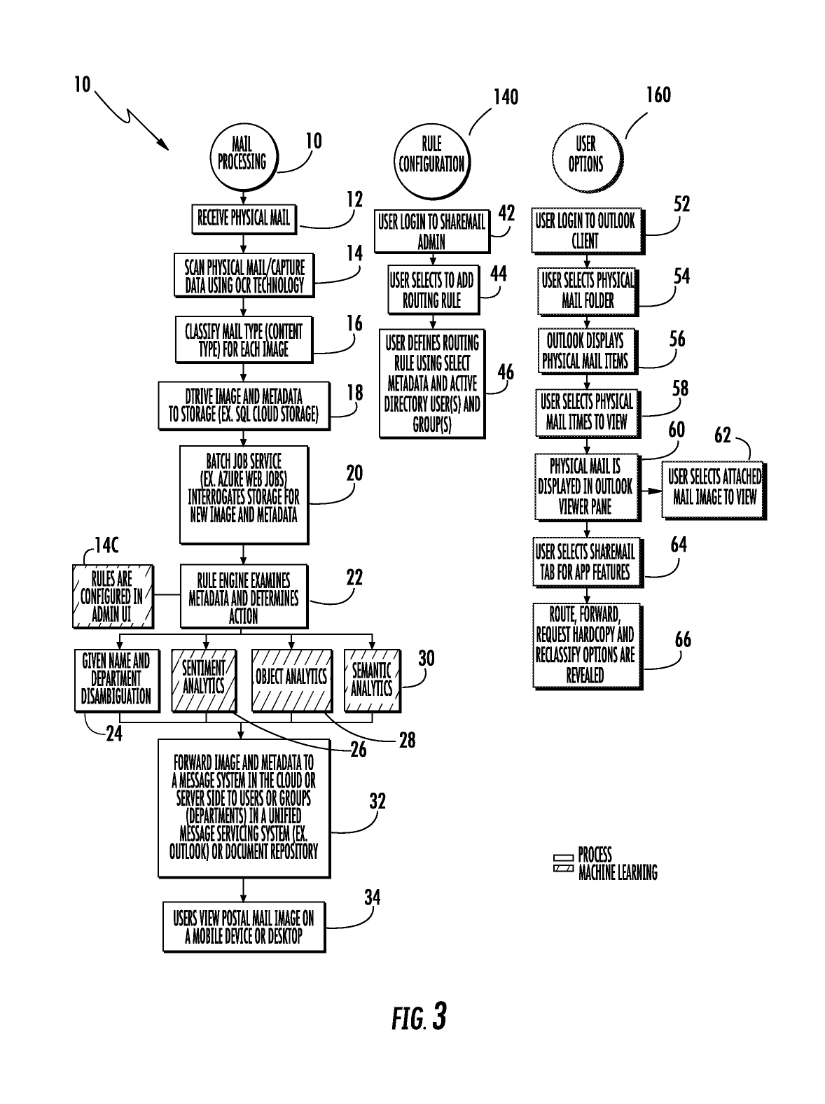

FIG. 1 shows an overview of a system 100 and mail processing method 10 for capturing and processing mail items, while FIG. 2 is sketch of the components only and FIG. 3 is a set of flow diagrams detailing the method 10 in more detail. The system and method referred to herein allow for the capture, routing, viewing and storing of digital copies of physical mail that has been received. The digital copies may be manipulated in a user's existing messaging or email client, and can also be integrated with any document and file management system that may also be installed.

In one embodiment of the method, the physical postal mail is first physically received from the postal services at step 12. It is then opened, and scanned and digitized using a scanner 110 at step 14. This step is typically carried out in a centralized mail room for a company, university, or other organization. It will be understood that any other image capture technology may be used, and that the actual scanning step is not important. The scanner or add-on software includes OCR (optical character recognition) software 115 to enable the system to convert an image of the mail item into readable text and can also do extraction and classification steps. Such systems are known, and are not further described herein. The physical mail item is typically scanned as an image file, such as a .pdf file, with the readable text from the OCR system being appended to the image file as metadata content, for example, as a .csv. .csc, JSON, or .xml attachment as a metadata file or other attachment. This step 16 includes a classification of each mail type (content type). An email or other message may then be created with both the image file and the metadata file as an attachment thereto, or the image and metadata content may be entered into a Unified Messaging System (for example, Microsoft Exchange Online/Exchange 2013, into document management or workflow process system directly, or any combination of steps as desired by the organization. Typically, step 18 involves the file being sent directly to a storage system 125 or to a web application platform 120 that stores the files in the storage system 125 (for example, a SQL, blob, table storage, or some other storage system) that the system 100 interfaces with.

In the case where it is not possible to scan a physical mail item in the usual way, for example, if the item is a package rather than a letter, a mailroom employee can use the system to create an email or other message with associated metadata content regarding the item, without incorporating an image file. Alternatively, an image file may include a photograph of the package label, which can be OCR'd to locate an addressee in the same way as other physical mail items. The metadata can include manually entered data such as the addressee name, data from OCR software if an image of the package is created, or data that has been created using a barcode scanner by scanning the package tracking label that is typically affixed to packages. The system can route an email or other message to the user to alert them that a package has been received, in the same way that is used for regularly scanned physical mail items, and thus analytics on package receipt can also be built in to the system. In case packages are held in a central mail room, or in an area with lockers having digital locks, the email or other message may include a pass code for accessing that area or locker.

The web application platform 120 comprises one or more of a variety of features, such as capabilities to support multiple web technologies, cloud computing capabilities, intranet portals, document and file management capabilities, collaboration processes among users and object, extranet support, websites, social network sites, EMS (enterprise management systems) application software, and many other features known to those of ordinary skill in the art. The web application platform 120 is supported by a data processor either on premises or in a cloud computing environment. It will be appreciated that the invention is not limited to the application being presented on a web application platform, and that the application may use any suitable language or format.

In step 18, the image file and metadata are uploaded to a database 130 that forms part of the web application platform 120. This database 130 may be a SQL database, or may use any other suitable database system. One preferred arrangement is a Microsoft Azure SQL database and Azure blob storage, but of course any suitable database or other storage system/language may be employed. An SQL database allows users to make relational queries against stored data, and so can be advantageous. The database may be web- or cloud-based, or may be locally hosted on one or more servers, depending on security or other needs of the organization. It will be appreciated that there is a great deal of flexibility that can be built into the system, particularly with regard to the location of the database 130, and that while a cloud computing platform is ideal for many users, security concerns may require other users to have dedicated servers for the database 130.

The database 130 forms a metadata capture and processing system. Typically the database at step 20 batches jobs, using a batch job service such as Azure Web Jobs to interrogate storage for newly uploaded image and metadata. The database 130 then uses a rule engine 140 to examine the metadata at step 22 and determine action to be taken. This typically involves creation of additional metadata. Capture and creation of metadata enables efficient processing of the physical mail items that are not otherwise possible with simple image-based systems.

Generally, the first step 24 in creating usable metadata involves recognizing a named entity that the physical mail item is addressed to, although of course systems for different organizations may be customized to have varying steps. The named entity might be an individual person, and/or a department or group within an organization. This step 24 involves a given name and department disambiguation. The system may use text taken directly from the OCR file of the mail contents, and can perform a simple search of a user/department directory, directory service, directory provider, HRIS or other system of reference with employees/departments (for example: Active Directory, Azure AD, PeopleSoft) in order to make a first iteration to identify the addressee. Text analytics may be performed to assess the accuracy of the OCR data that is being processed by the system, and which may involve scoring of the results generated to determine their reliability.

In a preferred arrangement, the system incorporates machine learning algorithms and processes 135 so that the accuracy of the addressee identification can be verified and remembered for the future. Typically, sentiment analysis 26, context/object analysis 28, and semantic analysis 30 can be performed to increase accuracy and also to increase the quantity and type of information that can be extracted from the physical mail item. There can be multiple passes of algorithms based on rules in the Rule Engine that are customizable for each organization. The additional or other machine learning functions can provide a better context for the mail to drive to a person, department or process.

For example, in addition to performing a name lookup, the system may also search within a location directory so as to match the user name with that user's location within the organization (such as physical office location, department name, building name, etc.). This data can be stored in memory in the system in another lookup table. The system can incorporate context-based algorithms and a scoring system to build up a score of the likely accuracy of the user identification, and can run additional identification tests to narrow down the correct addressee. This is particularly useful in larger organizations which may have multiple employees with the same name.

For example, if it is known that there are multiple users in an organization called “James Smith”, the system may be set so that only identifying a piece of mail using this single identifier produces a low confidence score that the correct addressee has been identified. However, given that each person may be in a different physical location, the system can be set to also identify a text string that relates to a physical address in order to increase the confidence that the correct addressee has been identified. This can include multiple levels such as department name, project name, and also historical context for that user. The system can learn and build up information over time to ensure accuracy. This can use multiple lookup tables, or any other method. For example, user database lookup table can include a physical office location associated with a user ID, so that if one user “James Smith” is located in the location “Jersey City”, while another is located in “Los Angeles”, then finding the characters corresponding to “Jersey City” in a piece of mail addressed to “James Smith” increases the confidence score for identification of the intended addressee. Failure of the system to find text that can be identified as an office location in the mail item, or failure to match an identified location with a user that is known to be at that location, would keep the confidence score low. The systems and methods can also use distance algorithms such as Levenshtein_distance_Algorithm to access the accuracy of the data from the OCR process when compared to the lookup tables of information. The particular algorithms used can be easily changed, depending on the needs of the organizational customer, or for any other reason.

Multiple passes of algorithms and lookups may be employed, and are not limited to name or addressee data. For example, in addition to matching a user name with the known physical office location for that user, the system can also scan through the text in the mail item for wording in the mail item that is likely to be related to that user. The system may be looking for wording that is relevant to the addressee's job title, department, workflow, project, etc., to build up context for the mail item. If one user “James Smith” works in the Accounts Payable department but another user with the same name works in the Marketing department, then the system can expect that text entries for “accounts payable”, “invoice”, “statement” and other relevant terms would appear in an item of mail that is intended for one of these users, whereas “marketing”, “campaign”, “promotional” and other similar wording may be expected more in mail items for the other.

The system 100 includes a management console 150 which is configurable at the organization level, to enable the organization to customize the processing of mail items. The mailroom administrator can set up rule configurations 140 for mail, user/department groupings, the configuration of the machine learning, the configuration of the route function, the configuration of the “request hard copy” function, forwarding rules, and analytics, which includes an analytics dashboard and reporting. It will be appreciated that there is a great deal of flexibility that can be built into the system, particularly with regard to the number of processing steps that are undertaken to route mail items.

A mail item may then be routed to one or more users at step 40. For example, even if an item of mail may only be addressed to a particular individual user, the organizational parameters may be set to share all items of mail on a particular project with an identified team of users. The system may also be set to route an item via email and also into an automated work process such as an accounts payable processing system.

In order to set up the Rule Engine 140, on which at least some of the algorithms are selected, an authorized user logs into the system's admin functions at step 42. The user selects to add a routing rule for mail at step 44. This might be, for example, to route mail to certain teams or groups based on the initial addressee individual or department. The user can select metadata and active directory user(s) and group(s) as recipients at step 46.

The machine learning algorithms 135 may incorporate feedback from users. For example, the system can allow the user to mark that the mail was incorrectly addressed, and can return the mail item for another attempt at addressing by the system. Various options can be presented to a user, such as “re-classify”, “forward”, and “route” in the native application. Alternatively, or in addition, the system can be set to record when an email with a mail item attachment was forwarded by the user directly to another user, process, or group, and can learn over time to automatically address or forward similar items. The system can search the forwarding emails for text such as “not mine” or “sent incorrectly” or any suitable wording, so that it can learn from mistakes. This function is also available to the mailroom administrator.

The system may also be set to look for words or phrases that either indicate a sentiment expressed in the mail, or a level of urgency. For example, a letter marked “urgent” may cause an urgent flag to be placed in the metadata content. Confidential items may be similarly flagged, and may cause the item to be password protected, or have restrictions on forwarding placed on the email or item. The system may be able to recognize terms that have been bolded, underlined, or placed in italics in the original mail item, and may flag those terms as being more important than other words or phrases in the mail item. The system may be set to copy any items that include words that might indicate a customer complaint to a certain user or team. Any items that include words relating to legal proceedings might be copied to a legal team. It will be appreciated that many other processes and text identification may be used to create flags and routing processes that are desirable in the particular organization that is using the system.

Once the various analytics and forwarding rules have been checked, and the system is ready to deliver the mail, at step 32, the system forwards the image and metadata to a message system in the cloud or hosted on servers to users or groups/departments in a unified message servicing system such as Exchange/Outlook, or a document repository. The user can view their postal mail image at step 34 on a mobile device or desktop.

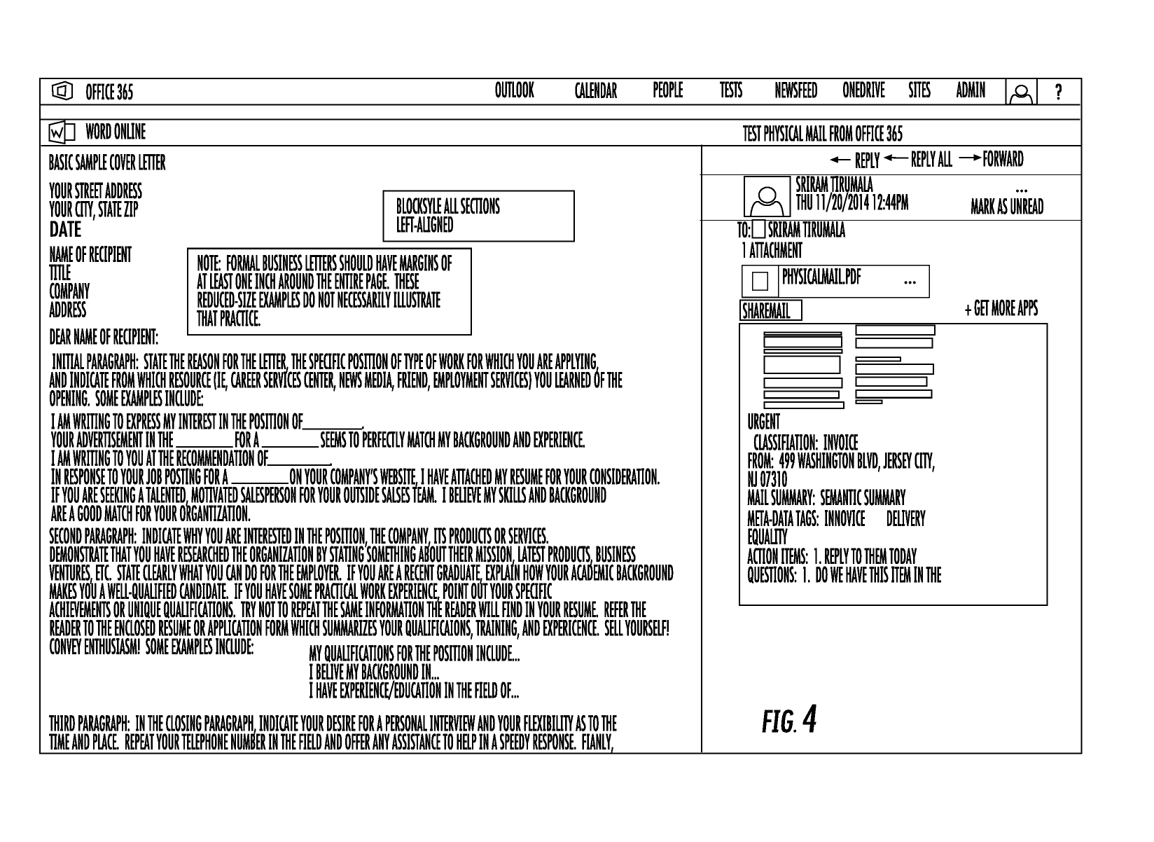

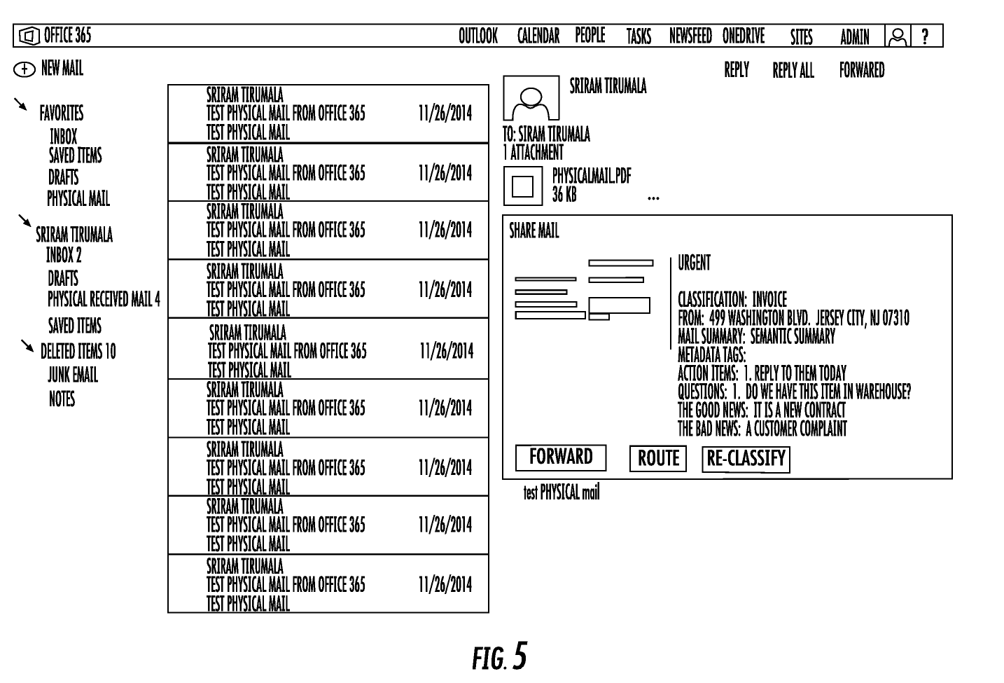

The end user can receive both an email with the mail item as an attachment, and can also see the result of the postal mail delivered, along with the metadata that is in context and expressed. This is presented in their unified messaging system 170 (such as Exchange) and then into their unified messaging client 175, for example, Microsoft Outlook, and is also supported on mobile platforms. Examples of the output to the user are shown in FIGS. 4 and 5. The metadata is presented as tags, and as a mail classification (urgent, invoice, etc.). The user is also provided with buttons that enable them to take action, such as “re-classify”, “forward”, and “route”. For example, the “route” option can place the mail item into a work process such as an accounts payable system. Other actions can be taken including request a hardcopy, search and they can also preview a PDF of the mail item. There are many options that can be set up in a system, as each system can be customized with various actions and buttons that can be created and adapted to the needs of each organization.

The user options 160 can be varied according to organizational needs. For example, the user can log in to their outlook client at step 52, and can select a physical mail folder (step 54). Outlook (or whichever messaging system is employed) displays the physical mail items (step 56). This provides a location for users based on user/group membership to look at their postal mail. Users may have the ability to sort and filter their physical postal mail items in their view the same way Outlook provides for email. As all physical mail will have been OCR'ed, search capabilities are available to search both the metadata and also the inside of the physical mail contents. The user selects which physical mail items to view (step 58) and the physical mail is displayed in an Outlook viewer pane (step 60). The user can select the attached mail image to view (step 62), or can select the ShareMail tab (step 64) for app features. Features that can be presented within the app can be to route, forward, request hardcopy and reclassify the mail item (step 66). It will be appreciated, that although the system and methods are described herein with respect to an app-based system, and in particular can use App for Office, the system and methods will work with any other unified messaging system, whether with or without an app model and can allow either a clientless deployment or client based deployment.

Users may be provided with the ability to see the PDF of the physical mail item with a mouse over. The system can provide a document viewer, for example a PDF viewer using a web based or client based document viewer such as Word Web App for this functionality, which can be integrated with Outlook.

After delivery of the mail item, and any actions taken by a user, the system can build up a database of mail activity across the organization. The information in this analytics database can be extracted and business intelligence and data visualization can be conducted on the data to help users to understand areas of improvement in compliance, operational efficiency, cross-transaction enablement, and quality of services within the various processes within the business.

The systems and methods described herein drive a mail activity analytics system that allows a user multiple actions or to define multiple characteristics or process steps with respect to postal mail. These characteristics/actions are defined by the metadata associated with the mail item, and give self-service reporting, predictive analytics, and prescriptive measures for providing operational efficiency, compliance, cross transaction enablement, quality of service and other enhanced business functions.

It is known that some of the most inefficient processes within the enterprise surround themselves around postal mail due to the sheer nature of it being non-digital. Digitizing copies of physical mail items, and using machine learning to help route it can help extend to other opportunities in the business such as HR, Accounts Payable and many others. By providing access to copies of physical mail items using Outlook (or whatever other unified messaging service that the organization already uses), and providing postal mail in the same place as their email helps drive an easier to use interface to help with culture and adoption. This makes the present system and method easy for users to adopt, and hence easy for organizations to roll out to their users.

The invention provides a platform for consolidating all messaging which would include postal mail for the user in a business both big and small. This allows them to have intelligently captured postal mail and have it come to their unified messaging system and provide both workflow functions and visibility functions for the users and organization.

The system and method described herein helps to overcome challenges with automating information capture on physical mail, and obviates the need for an organization to have a separate software system or mail management program. Once content is in the organization's unified messaging system, the ability to drive workflow and visibility of the mail items to users is advantageous over known systems. Leveraging upon cloud technology tremendously shortens the gap of being able to seamlessly integrate with third party messaging systems and support of different frameworks. The system and method also automatically extracts and validates information from incoming business mail (in paper and electronic formats) and distributes it to electronic workflows. While digital mail can handle high volumes of all document formats (structured, semi-structured, and unstructured), it reduces time and costs spent on manually sorting and distributing mail, while boosting productivity and improving service quality with faster response times. In addition, it is cheaper for organizations to use low cost labor and systems to provide the ability to take unstructured data and make it structured versus the people within a department that might be a VP, director, manager, or critical admin assistant that would otherwise need to take time to route mail items appropriately.

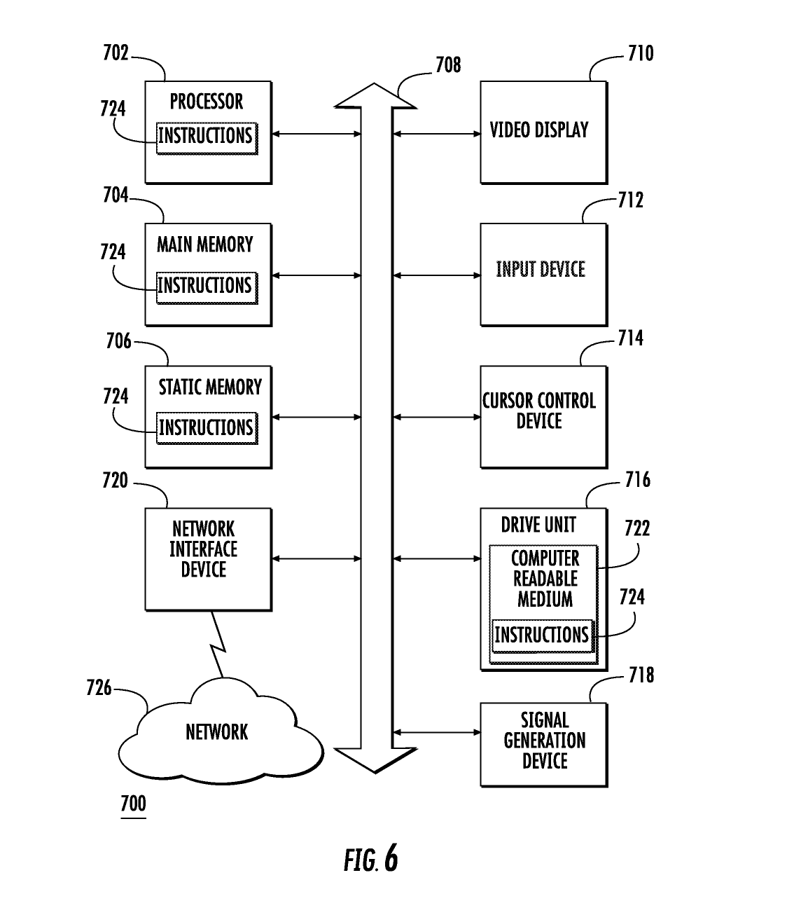

FIG. 6 illustrates an embodiment of a general computer system 700 on which the systems and methods described herein may be run. The systems and methods of the invention may be carried out on any suitable computer system, web-based/cloud-based platform, or the like, and FIG. 6 is merely exemplary. The computer system 700 includes instructions that are executed to cause the computer system to perform any one or more of the methods or computer based functions disclosed herein. Computer system 700 may operate as a standalone device or may be connected, such as by using a network, to other computer systems or peripheral devices. Computer system 700 can operate as a server or as a client user computer in a server-client user network environment, or as a peer computer system in a peer-to-peer (or distributed) network environment. Computer system 700 can also be implemented as or incorporated into various devices, such as a personal computer (PC), a tablet PC, a set-top box(STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing instructions (sequential or otherwise) that specify actions to be taken by that machine. In a particular embodiment, computer system 700 can be implemented using electronic devices that provide voice, video, or data communication. Further, while computer system 700 is illustrated as a single item, the term “system” shall also be taken to include any collection of systems or sub-systems that individually or jointly execute a set of, or multiple sets of instructions to perform one or more computer functions.

Computer system 700 includes a processor 702, a main memory 704, a static memory 706, a video display unit 710, an input device 712, a cursor control device 714, a disk drive unit 716, a signal generation device 718, and a network interface device 720, that can communicate with each other via a bus 708. Processor 702 represents a central processing unit (CPU), a graphics processing unit (GPU), another processing device, or a combination thereof. Video display unit 710 represents a liquid crystal display (LCD), an organic light emitting diode (OLED), a flat panel display, a solid-state display, a cathode ray tube (CRT), another display device, or a combination thereof. In a particular embodiment, input device 712 represents a keyboard, and cursor control device 714 represents a mouse. Alternatively, input device 712 and cursor control device 714 can be combined with video display unit 710 in the form of a touchpad or touch sensitive screen. Disk drive device 716 represents an information storage device including a disk drive, a solid state drive (SSD), an external hard drive, another information storage device, or a combination thereof. Signal generation device 718 represents a speaker, a remote control unit, another device, or a combination thereof. Network interface device 720 communicates with a network 726. Disk drive device 716 includes a computer-readable medium 722 for storing one or more sets of instructions 724. Additionally, main memory 704 and static memory 706 store one or more additional sets of instructions 724. The sets of instructions 724 represent programs, software, firmware, machine-executable code, other instructions, or a combination thereof. Also, instructions 724 can be embedded in a device of computer system 700. In a particular embodiment, instructions 724 represent one or more of the methods or logic as described herein. Processor 702 operates to execute instructions 724 to perform one or more of the methods or logic as described herein.

The previously discussed modules, devices, systems, or other elements (hereinafter “module,” can be implemented in hardware, software, or any combination thereof. Each module may include one or more computer systems. When a module includes more than one computer system, the functions of the module can be distributed across the multiple computer systems in a symmetric manner, i.e., each computer system performs the same type of tasks, or in an asymmetric manner, i.e., two computer systems of the module may perform different tasks.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGS. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

1. A method of digitally capturing and processing physical mail items in a computer system, comprising the steps of:
scanning an image of the mail item;
reading text from the scanned image using optical character recognition (OCR) to create metadata content attached to the image;
creating a digital mail file comprising the scanned image and the metadata content;
comparing the metadata content with data stored in memory of the computer system to identify an addressee of the mail item; and
using the data in the metadata content to perform an action on the digital mail file, the action including at least forwarding the digital mail file via email to the identified addressee.

2. The method according to claim 1, wherein the step of comparing the metadata with data stored in memory of the computer file includes performing a lookup in a directory of stored users of the computer system to match a text string in the metadata with a user name to identify the addressee.

3. The method according to claim 2, wherein the step of comparing the metadata incorporates machine learning algorithms so that the accuracy of the addressee identification can be checked.

4. The method according to claim 3, wherein the machine learning algorithms include distance algorithms to produce a confidence score of the accuracy of the match between the OCR text and the identified user name.

5. The method according to claim 3, wherein the identified user name is compared by running an additional lookup on further text strings identified from the OCR text with additional information stored in memory, the additional information including at least one of physical location information for the user, department information for the user, project information for the user, and job context information for the user.

6. The method according to claim 1, wherein the step of identifying an addressee of the mail item includes the step of comparing text strings from the OCR text with context words or phrases stored in memory of the computer system, the context words or phrases including identified subject matter, sentiment, urgency, process, departmental, or project-related words or phrases that are selectable and maintainable by a user of the system, and wherein the addressee of the mail item includes a group, team, department or process associated with the context words or phrases in addition to or instead of any named addressee of the mail item.

7. The method according to claim 1, further including a step of classifying the mail item, wherein the classifying step includes comparing text strings from the OCR text with classifying words or phrases stored in memory of the computer system, the classifying words or phrases including identified subject matter, sentiment, urgency, process, departmental, or project-related words or phrases that are selectable and maintainable by a user of the system, and wherein a classification tag can be appended to the digital mail file for highlighting the assigned classification to a user of the system.

8. The method according to claim 1 further including a mail activity analytics step, wherein the computer system records in memory actions taken with respect to mail items, and wherein an actions database is created such that analytics, and reporting can be carried out on the actions database.

9. The method according to claim 8, wherein the analytics carried out on the actions database includes at least one of business intelligence analytics and data visualization.

10. A method of digitally capturing and processing physical mail items in a computer system, comprising the steps of:
creating metadata content relating to an item of physical mail;
creating a digital mail file comprising the metadata content, and optionally, an image file comprising a captured image of the physical mail item;
comparing the metadata with data stored in memory of the computer system to identify an addressee of the mail item; and
using the data in the metadata content to perform an action on the digital mail file, the action including at least forwarding the digital mail file via email to the identified addressee.

11. The method according to claim 10, the digital mail file including a pass code for retrieving the item of physical mail from a locker.

12. A computer system for digitally capturing and processing physical mail items, comprising:
a memory that stores instructions;
a processor that executes the instructions to perform operations, the operations comprising:
reading text from a scanned image of the mail item using optical character recognition (OCR) to create metadata content attached to the image;
creating a digital mail file comprising the scanned image and the metadata content;
comparing the metadata with data stored in memory of the computer system to identify an addressee of the mail item; and
using the data in the metadata content to perform an action on the digital mail file, the action including at least forwarding the digital mail file via email to the identified addressee.

13. The computer system according to claim 12, further comprising a unified messaging system, the computer system incorporating the digital mail file into the unified messaging system.

14. The computer system according to claim 12, wherein the operations further comprise performing a lookup in a directory of stored users of the computer system to match a text string in the metadata with a user name to identify the addressee.

15. The computer system according to claim 14, wherein the operations further comprise incorporating machine learning algorithms so that the accuracy of the addressee identification can be checked.

16. The computer system according to claim 15, wherein the machine learning algorithms include distance algorithms to produce a confidence score of the accuracy of the match between the OCR text and the identified user name.

17. The computer system according to claim 15, wherein the operations further comprise comparing the identified user name by running an additional lookup on further text strings identified from the OCR text with additional information stored in memory, the additional information including at least one of physical location information for the user, department information for the user, project information for the user, and job context information for the user.

18. The computer system according to claim 12, wherein the operations further comprise comparing text strings from the OCR text with context words or phrases stored in memory of the computer system, the context words or phrases including identified subject matter, sentiment, urgency, process, departmental, or project-related words or phrases that are selectable and maintainable by a user of the system, and wherein the addressee of the mail item includes a group, team, department or process associated with the context words or phrases in addition to or instead of any named addressee of the mail item.

19. The computer system according to claim 12, wherein the operations further comprise classifying the mail item, wherein the classifying operation includes comparing text strings from the OCR text with classifying words or phrases stored in memory of the computer system, the classifying words or phrases including identified subject matter, sentiment, urgency, process, departmental, or project-related words or phrases that are selectable and maintainable by a user of the system, and wherein a classification tag can be appended to the digital mail file for highlighting the assigned classification to a user of the system.

20. The computer system according to claim 12, wherein the operations further comprise analyzing mail activity, wherein the computer system records in memory actions taken with respect to mail items, and wherein an actions database is created such that analytics, and reporting, can be carried out on the actions database.

21. A computer system for digitally capturing and processing physical mail items, comprising:
a memory that stores instructions;
a processor that executes the instructions to perform operations, the operations comprising:
creating metadata content relating to an item of physical mail;
creating a digital mail file comprising the metadata content, and optionally, an image file comprising a captured image of the physical mail item;
comparing the metadata with data stored in memory of the computer system to identify an addressee of the mail item; and
using the data in the metadata content to perform an action on the digital mail file, the action including at least forwarding the digital mail file via email to the identified addressee.
